(19) United States
(12) Patent Application Publication
(10) Pub. No.: US 2010/0027799 A1
(43) Pub. Date: Feb. 4, 2010

(54) ASYMMETRICAL DELAY AUDIO CROSSTALK CANCELLATION SYSTEMS, METHODS AND ELECTRONIC DEVICES INCLUDING THE SAME

(75) Inventors: Eric Douglas Romesburg, Chapel Hill, NC (US); William Chris Eaton, Cary, NC (US)

Correspondence Address: MYERS BIGEL SIBLEY & SAJOVEC, P.A., P.O. BOX 37428, RALEIGH, NC, 27627, US

(73) Assignee: Sony Ericsson Mobile Communications AB

(21) Appl. No.: 12/183,525

(22) Filed: Jul. 31, 2008

(51) Int. Cl. H04R 5/00

(52) U.S. Cl. 381/28; 381/1

(57) ABSTRACT

Crosstalk cancellation systems for left and right channel stereo audio signals that are played over left and right stereo loudspeakers include circuitry that is configured to apply more crosstalk cancellation delay to a difference signal between the left and right stereo audio signals, than to a sum signal of the left and right channel stereo signals. The circuitry may be configured to apply no crosstalk cancellation delay to the sum signal. Related crosstalk cancellation methods and electronic devices incorporating same are also disclosed.

### FIELD OF THE INVENTION

This invention relates to audio signal processing systems and methods, and more specifically to audio crosstalk cancellation systems and methods, and electronic devices including same.

### BACKGROUND OF THE INVENTION

Mobile telephones, portable music players and other types of portable electronic devices often include a speaker for playing audio signals, such as voice audio signals, music audio signals, ringtones and the like. For example, mobile telephones generally include a low power speaker located in an earpiece that is pressed against the ear of the user of the telephone. Received audio signals are played over the speaker, and can be heard by the telephone's user.

There is now increasing interest in mobile phones, music players and other portable electronic devices with stereo loudspeakers for a richer experience of music, videos, games, ringtones, etc. However, due to the small spacing between the stereo loudspeakers, the closely spaced loudspeakers are generally perceived by the user as a monophonic signal source when the portable electronic device is held away from the ears. In one conventional example, the stereo loudspeaker ports of a mobile telephone are separated by about 23 mm. Such closely spaced loudspeakers are perceived by the user as a single monophonic source if the mobile telephone is more than 400 mm away from the ears.

Crosstalk cancellation systems and methods have been introduced to allow a user to experience stereo reproduction from loudspeakers that are closely spaced apart from one another. In general, a crosstalk cancellation circuit includes a delay block or element for the left channel audio signal, and a delay block or element for the right channel audio signal. The delay block matches the difference in the path delay, and optionally in the frequency response, between the two speaker outputs to one ear. Thus, a delayed and out-of-phase version of the left channel audio signal is added to the right channel audio signal, so that the left channel audio signal is canceled at the right ear. Similarly, a delayed and out-of-phase version of the right channel audio signal is added to the left channel audio signal, so that the right channel audio signal is canceled at the left ear. The stereo effect can be preserved, notwithstanding the close spacing of the stereo loudspeakers relative to the distance to the user's ears.

Unfortunately, however, conventional crosstalk cancellation systems and methods can have a deleterious effect on the overall loudness of the stereo audio signal, and this attenuation can vary depending upon the frequency and placement of a given instrument in the stereo image. For example, in the above-described mobile telephone with loudspeaker spacing of about 23 mm, a crosstalk cancellation circuit may provide a delay of about 21 msec. This may provide a loss of about −10.5 dB for monophonic signals below about 4.8 kHz, which may decrease the overall loudness of the signal, and may also adversely affect loudness of bass and vocals relative to other instruments.

### SUMMARY OF THE INVENTION

Some embodiments of the invention provide crosstalk cancellation systems for left and right channel stereo audio signals that can be played over left and right stereo loudspeakers. These crosstalk cancellation systems include circuitry that is configured to apply more crosstalk cancellation delay to a difference signal between the left and right stereo audio signals, than to a sum signal of the left and right channel stereo signals. In some embodiments, the circuitry is configured to apply a predetermined (nonzero) crosstalk cancellation delay to the difference signal, and substantially no crosstalk cancellation delay to the sum signal. In other embodiments, the circuitry is configured to apply at least ten times more crosstalk cancellation delay to the difference signal than to the sum signal. Accordingly, asymmetrical delay audio crosstalk cancellation systems may be provided by providing more crosstalk cancellation delay to the difference signal than to the sum signal. More crosstalk cancellation delay may be provided by applying longer crosstalk cancellation delay signal time and/or larger crosstalk cancellation delay signal scaling to the difference signal than to the sum signal.

In some embodiments, the circuitry includes a separator, a crosstalk canceller and a recombiner. The separator is configured to separate the left and right channel stereo audio signals into the sum and difference signals. The crosstalk canceller is configured to apply the more crosstalk cancellation delay to the difference signal than to the sum signal. The recombiner is configured to recombine the difference signal to which the more crosstalk cancellation delay has been applied, and the sum signal to which less crosstalk cancellation delay has been applied, to obtain crosstalk canceled left and right channel stereo audio signals.

In other embodiments, the circuitry comprises a delay element that is responsive to the difference signal to generate a delayed replica of the difference signal, and a combiner that is configured to sum the difference signal and the delayed replica of the difference signal. In these embodiments, the crosstalk cancellation system is not configured to combine the sum signal and a delayed replica thereof. The delayed replica may not be frequency dependent in some embodiments. In other embodiments, the delay may vary with frequency.

In still other embodiments, the circuitry comprises a first combiner that is responsive to the left and right channel stereo audio signals to generate the difference signal; a delay element that is responsive to the difference signal to generate a delayed replica of the difference signal; a second combiner that is responsive to the difference signal and to the delayed replica of the difference signal to generate a crosstalk canceled difference signal; a third combiner that is responsive to the left and right channel stereo audio signals to generate the sum signal that is free of a crosstalk canceled sum signal; a fourth combiner that is responsive to the crosstalk canceled difference signal and to the sum signal that is free of a crosstalk canceled sum signal to generate a left channel output signal; and a fifth combiner that is responsive to the crosstalk canceled difference signal and to the sum signal that is free of a crosstalk canceled sum signal to generate a right channel output signal. In some embodiments, the first and fifth combiners comprise subtractors, and the second, third and fourth combiners comprise summers.

Moreover, other embodiments can provide a high pass filter between the first combiner and the delay element, such that the delay element is responsive to a high pass filtered difference signal to generate a high pass filtered delayed replica of the difference signal. Moreover, the second combiner is responsive to the high pass filtered difference signal and to the high pass filtered delayed replica of the difference signal to generate the crosstalk canceled difference signal.

Embodiments of the invention have been described above in connection with crosstalk cancellation systems. However, other embodiments of the present invention can provide crosstalk cancellation methods for left and right channel stereo audio signals that are played over left and right channel stereo loudspeakers. These crosstalk cancellation methods can include processing the left and right channel stereo audio signals so as to apply more crosstalk cancellation delay to a difference signal between the left and right stereo audio signals, than to a sum signal of the left and right channel stereo audio signals. Analogous methods to all of the embodiments described above may be provided.

Moreover, other embodiments of the present invention provide an electronic audio reproducing system that includes a source of left and right channel stereo audio signals, left and right channel stereo loudspeakers, and a crosstalk cancellation circuit according to any of the embodiments described herein that is configured to apply more crosstalk cancellation delay to a difference signal between the left and right stereo audio signals than to a sum signal of the left and right channel stereo signals. A stereo amplifier also is provided that is configured to amplify left and right stereo audio signals to which crosstalk cancellation has been applied by the crosstalk cancellation circuit, and to provide the signals so amplified to the left and right channel loudspeakers.

### BRIEF DESCRIPTION OF THE DRAWINGS

The accompanying drawings, which are included to provide a further understanding of the invention and are incorporated in and constitute a part of this application, illustrate certain embodiment(s) of the invention. In the drawings:

FIG. 1 illustrates a mobile telephone according to various embodiments of the invention.

FIGS. 2A-2B illustrate a flip-type mobile telephone according to various embodiments of the invention.

FIGS. 3A-3B illustrate a slider-type mobile telephone according to various embodiments of the invention.

FIG. 4 is a schematic block diagram of a portable electronic device according to various embodiments of the invention.

FIGS. 5-11 are block diagrams of electronic audio reproducing systems including crosstalk cancellation according to various embodiments of the present invention.

FIG. 12 is a flowchart of operations that may be performed to provide crosstalk cancellation according to various embodiments of the present invention.

FIG. 13 is a block diagram of a conventional crosstalk cancellation circuit.

FIG. 14 is a block diagram of an equivalent circuit to FIG. 13 that was generated for analysis purposes according to various embodiments of the present invention.

FIGS. 15-17 are block diagrams of electronic audio reproducing systems including crosstalk cancellation according to various other embodiments of the present invention.

### DETAILED DESCRIPTION

The present invention now will be described more fully hereinafter with reference to the accompanying figures, in which embodiments of the invention are shown. This invention may, however, be embodied in many alternate forms and should not be construed as limited to the embodiments set forth herein.

Accordingly, while the invention is susceptible to various modifications and alternative forms, specific embodiments thereof are shown by way of example in the drawings and will herein be described in detail. It should be understood, however, that there is no intent to limit the invention to the particular forms disclosed, but on the contrary, the invention is to cover all modifications, equivalents, and alternatives falling within the spirit and scope of the invention as defined by the claims. Like numbers refer to like elements throughout the description of the figures.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises”, “comprising,” “includes” and/or “including” (and variants thereof) when used in this specification, specify the presence of stated features, integers, steps, operations, elements, and/or components, but do not preclude the presence or addition of one or more other features, integers, steps, operations, elements, components, and/or groups thereof. Moreover, when an element is referred to as being “responsive” to another element/step (and variants thereof), it can be directly responsive to the other element/step, or intervening elements/steps may be present. In contrast, when an element/step is referred to as being “directly responsive” to another element/step (and variants thereof), there are no intervening elements/steps present. As used herein the term “and/or” includes any and all combinations of one or more of the associated listed items and may be abbreviated as “/”.

It will be understood that, although the terms first, second, etc. may be used herein to describe various elements, these elements should not be limited by these terms. These terms are only used to distinguish one element from another.

The present invention is described below with reference to block diagrams and/or flowchart illustrations of methods, apparatus (systems and/or devices) and/or computer program products according to embodiments of the invention. It is understood that a block of the block diagrams and/or flowchart illustrations, and combinations of blocks in the block diagrams and/or flowchart illustrations, can be implemented by computer program instructions. These computer program instructions may be provided to a processor of a general purpose computer, special purpose computer, digital signal processor and/or other programmable data processing apparatus to produce a machine, such that the instructions, which execute via the processor of the computer and/or other programmable data processing apparatus, create means (functionality) and/or structure for implementing the functions/acts specified in the block diagrams and/or flowchart block or blocks.

These computer program instructions may also be stored in a computer-readable memory that can direct a processor of the computer and/or other programmable data processing apparatus to function in a particular manner, such that the instructions stored in the computer-readable memory produce an article of manufacture including instructions which implement the function/act as specified in the block diagrams and/or flowchart block or blocks.

The computer program instructions may also be loaded onto a computer and/or other programmable data processing apparatus to cause a series of operational steps to be performed on the computer and/or other programmable apparatus to produce a computer-implemented process such that the instructions which execute on the computer or other programmable apparatus provide steps for implementing the functions/acts specified in the block diagrams and/or flowchart block or blocks.

Accordingly, the present invention may be embodied in hardware and/or in software (including firmware, resident software, micro-code, etc.) that runs on a processor such as a digital signal processor, collectively referred to as “circuitry” or “a circuit”. Furthermore, the present invention may take the form of a computer program product on a computer-usable or computer-readable storage medium having computer-usable or computer-readable program code embodied in the medium for use by or in connection with an instruction execution system. In the context of this document, a computer-usable or computer-readable medium may be any medium that can contain, store, communicate or transport the program for use by or in connection with the instruction execution system, apparatus, or device.

The computer-usable or computer-readable medium may be, for example but not limited to, an electronic, magnetic, optical, electromagnetic or semiconductor system, apparatus or device. More specific examples (a non-exhaustive list) of the computer-readable medium would include the following: a portable computer diskette, a random access memory (RAM), a read-only memory (ROM), an erasable programmable read-only memory (EPROM or Flash memory), and a portable optical and/or magnetic media, such as a flash disk or CD-ROM.

It should also be noted that in some alternate implementations, the functions/acts noted in the blocks may occur out of the order noted in the flowcharts. For example, two blocks shown in succession may in fact be executed substantially concurrently or the blocks may sometimes be executed in the reverse order, depending upon the functionality/acts involved. Moreover, the functionality of a given block of the flowcharts and/or block diagrams may be separated into multiple blocks and/or the functionality of two or more blocks of the flowcharts and/or block diagrams may be at least partially integrated. Finally, other blocks may be added/inserted between the blocks that are illustrated. For example, a compressor may be added, as desired.

Some embodiments of the present invention provide crosstalk cancellation systems, devices and/or methods for left and right channel stereo audio signals that are played over left and right channel stereo loudspeakers. As used herein, the terms “left” and “right” are used to distinguish two signals of a stereo signal from one another. However, in other embodiments, a left channel stereo audio signal may be termed a “right channel audio signal” and, similarly, a right channel stereo audio signal may be termed a “left channel audio signal” without departing from the scope of the present invention.

Crosstalk cancellation systems according to various embodiments of the invention include circuitry that is configured to apply more crosstalk cancellation delay to a difference signal between the left and right stereo audio signals, than to a sum signal of the left and right channel stereo signals. The sum signal of the left and right stereo audio signals may also be referred to as a monophonic, mono, center or middle signal. Moreover, the difference signal between the left and right stereo audio signals may also be referred to as a side signal.

Portable electronic devices, such as wireless mobile telephones, according to various embodiments of the invention, can have a variety of shapes, sizes and/or housing types. Examples of several types of mobile telephone housings are shown in FIGS. 1 to 3B. For example, a mobile telephone 100A according to some embodiments is illustrated in FIG. 1. The mobile telephone 100A includes a housing 15 that houses and protects the electronics of the mobile telephone 100A. The mobile telephone 100A includes an LCD display 18 and a keypad 16. The mobile telephone 100A further includes a multifunction control/input button 22 that can be used to select menu items and/or to input commands to the mobile telephone 100A.

The mobile telephone 100A includes a microphone port 14 and an earphone/speaker 20. The housing 15 may be designed to form an acoustic seal to the user's ear when the earphone/speaker 20 is placed against the user's head. The mobile telephone 100A may be configured to play video files and or audio files, such as song files, which may be stereophonic signals. Accordingly, the mobile telephone 100A includes, in addition to the earphone/speaker 20, a pair of amplified stereophonic (stereo) speakers 12L, 12R, that may be used, for example, to play stereophonic audio. The amplified speakers 12L, 12R may also be used as loudspeakers during hands-free speakerphone operations. The amplified speakers 12L, 12R may be positioned away from the earphone/speaker 20 for safety (i.e., in case the user puts the telephone to his/her ear while amplified sound is being played over the speakers 12L, 12R).

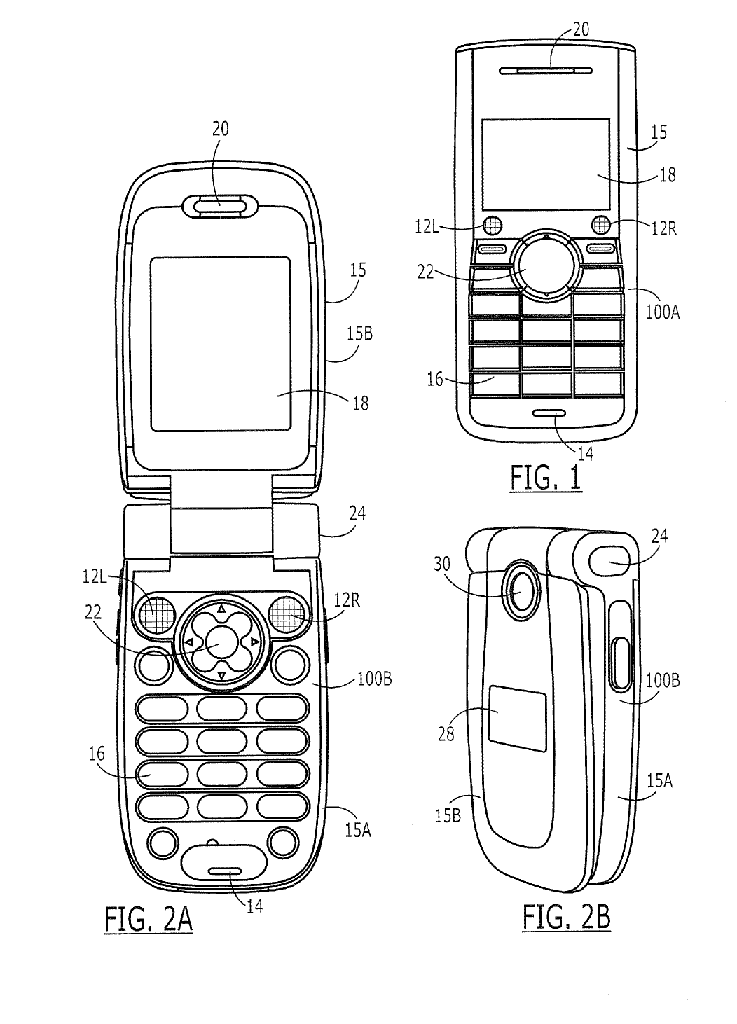

A flip-style mobile telephone 100B is illustrated in FIGS. 2A and 2B. The flip-style mobile telephone 100B is shown in the open position in FIG. 2A and in the closed position in FIG. 2B. The mobile telephone 100B includes a housing 15 that includes a lower housing 15A and an upper housing, or “flip” portion 15B that are rotatably connected by a hinge 24. The mobile telephone 100B includes a primary LCD display 18 on the inside of the flip 15B and a keypad 16 on the inside of the lower housing 15A. The mobile telephone 100B further includes a multifunction control/input button 22.

The mobile telephone 100B includes a microphone port 14 on the lower housing 15A and an earphone/speaker 20 on the inside of the flip 15B. The mobile telephone 100B further includes a pair of amplified stereophonic speakers 12L, 12R on the lower housing 15B. The amplified speakers 12L, 12R may also be used as loudspeakers during hands-free speakerphone operations. As also shown in FIG. 2B, a secondary display 28 and a camera lens 30 may be located on the outside of the flip 15B.

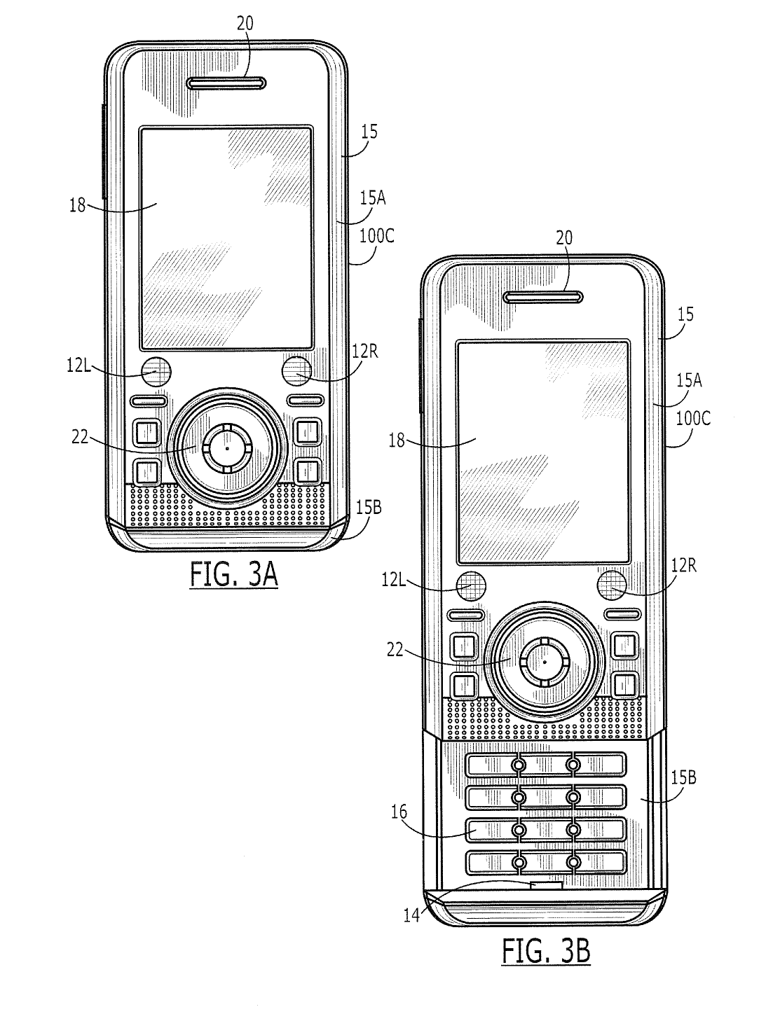

A slider-style mobile telephone 100C is illustrated in FIGS. 3A and 3B. The slider-style mobile telephone 100C is shown in the closed (retracted) position in FIG. 3A and the open (extended) position in FIG. 3B. The mobile telephone 100C includes a housing 15 that includes an upper housing 15A and a retractable lower housing 15B that is slidably connected to the upper housing 15A. The mobile telephone 100C includes an LCD display 18 on the outside of the upper housing 15A and a keypad 16 on the lower housing 15B. The keypad 16 is hidden when the mobile telephone 100C is in the retracted position, as shown in FIG. 3A. The mobile telephone 100C further includes a multifunction control/input button 22 on the upper housing 15A that may be accessed by a user when the telephone 100C is in the closed/retracted position.

The mobile telephone 100C includes a microphone port 14 on the lower housing 15B and an earphone/speaker 20 on the upper housing 15A. The mobile telephone 100C further includes a pair of amplified stereophonic speakers 12L, 12R on the outside of the upper housing 15A. The amplified speakers 12L, 12R may also be used as loudspeakers during hands-free speakerphone operations.

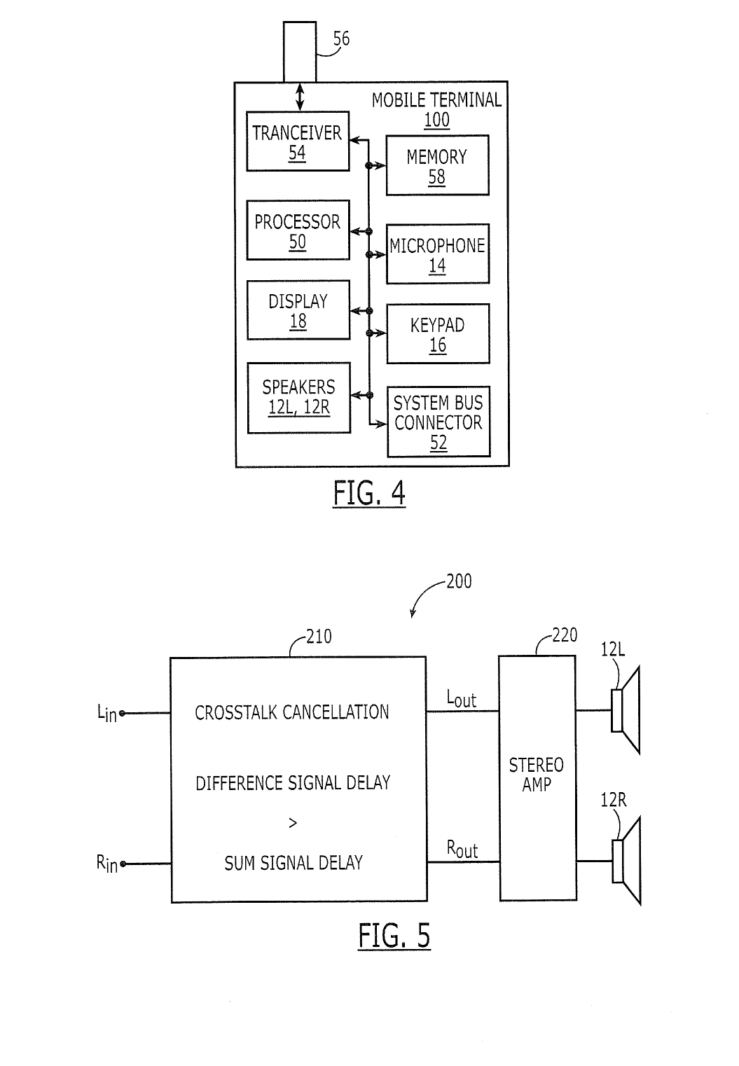

An exemplary block diagram of a personal electronic device, such as a wireless mobile telephone 100, is shown in FIG. 4. As shown therein, an exemplary mobile telephone 100 in accordance with some embodiments of the present invention includes a keypad 16, a display 18, a transceiver 54, a memory 58, a microphone 14, and stereo speakers 12L, 12R that communicate with and/receive signals from a processor 50. The processor may include a digital signal processor that provides crosstalk cancellation according to various embodiments of the invention. The transceiver 54 typically includes a transmitter circuit and a receiver circuit, which cooperate to transmit and receive radio frequency signals to remote transceivers via an antenna 56, which may be positioned internal or external to the housing of the telephone 100. The radio frequency signals transmitted between the mobile telephone 100 and the remote transceivers may comprise both traffic signals (e.g. voice) and control signals (e.g., paging signals/messages for incoming calls), which are used to establish and maintain communication with another party or destination.

The processor 50 is also coupled to a system bus connector 52, to which accessory devices may be attached. The accessory devices may communicate with the processor 50 through the system bus connector 52. In particular, the system bus connector 52 may provide conductors that permit the processor 50 to transmit/receive analog and/or digital audio and/or video signals, as well as data and/or control signals, to connected accessories. The system bus connector 52 may also provide power and/or ground connections for accessories attached thereto.

The memory 58 may be a general purpose memory that is used to store both program instructions for the processor 50 as well as data, such as audio data, video data, configuration data, and/or other data that may be accessed and/or used by the processor 50. The memory 58 may include a nonvolatile read/write memory, a read-only memory and/or a volatile read/write memory. In particular, the memory 58 may include a read-only memory in which basic operating system instructions are stored, a non-volatile read/write memory in which re-usable data, such as configuration information, directory information, and other information may be stored, as well as a volatile read/write memory, in which short-term instructions and/or temporary data may be stored. The memory 58 may be further configured to store a digital information signal such as a digital audio and/or video signal generated or received by the mobile telephone 100.

The transceiver 54 is configured to communicate data over a wireless interface to a remote unit, such as a cellular base station, which communicates with a mobile telephone switching office (MTSO) via a wired or wireless link.

The transceiver 54 can include, for example, a cellular communication module, a Bluetooth module, and/or a wireless local area network (WLAN) module. With a cellular communication module, the mobile telephone 100 can communicate with a base station using one or more cellular communication protocols such as, for example, Advanced Mobile Phone Service (AMPS), ANSI-136, Global Standard for Mobile (GSM) communication, General Packet Radio Service (GPRS), enhanced data rates for GSM evolution (EDGE), code division multiple access (CDMA), wideband-CDMA, CDMA2000, and Universal Mobile Telecommunications System (UMTS). The base station may be connected to a Mobile Telephone Switching Office (MTSO), which, in turn, may be connected to a telephone network, a computer data communication network (e.g. the internet), and/or another network.

With a Bluetooth module, a mobile telephone 100 can communicate with other wireless communication terminals via an ad-hoc network. With a WLAN module, the mobile telephone 100 can communicate through a WLAN router (not shown) using a communication protocol that may include, but is not limited to, 802.11a, 802.11b, 802.11e, 802.11g, 802.11i, 802.11n, etc.

As noted above, a mobile telephone 100 can be configured to play left and right channel stereo audio signals, that are received by the telephone, stored in the telephone and/or are generated in the telephone, over amplified stereo loudspeakers 12L, 12R. The left and right channel stereo audio signals are played at a loud level so as to be heard by a listener located some distance away from the telephone.

Other portable electronic devices according to various embodiments of the present invention may function as standalone portable audio players and, as such, may not include the antenna 56, transceiver 54 or microphone 14. A user input device, such as a keypad 16 and a display 18 may be provided. Such devices may be embodied as MP3 players, iPod devices, etc., that include stereo loudspeakers 12L, 12R. Moreover, the functionality of a stereo audio player according to various embodiments of the invention may also be combined with other devices, such as portable navigation devices; personal digital assistant devices that can also provide email, calendaring, organizing, etc., functions; and/or conventional laptop, palmtop and/or other portable general purpose computing devices that include stereo loudspeakers 12L, 12R.

Crosstalk cancellation systems according to various embodiments of the invention may comprise circuitry that is configured to apply more crosstalk cancellation delay to a difference signal between the left and right stereo audio signals, than to a sum signal of the left and right channel stereo audio signals. The circuitry may be embodied in a Digital Signal Processor (DSP), which can be included in processor 50 and/or may be separate therefrom. Moreover, the circuitry may be embodied, at least in part, as discrete electronic devices including discrete delay elements, filters, summing nodes, etc., according to any of the embodiments described herein. In other embodiments, the circuitry may be embodied partially in a digital signal processor and partially in discrete electronic devices.

FIG. 5 is a block diagram of an electronic audio reproducing system including crosstalk cancellation systems and methods according to various embodiments of the present invention. The electronic audio reproducing system 200 may be embodied, for example, in any of the devices described in connection with FIGS. 1-4, or in any other electronic device that includes an electronic audio reproducing system. As shown in FIG. 5, the electronic audio reproducing system 200 includes a source of left and right stereo audio signals Lin, Rin. The source may be a memory system, such as a solid state memory and/or a hard drive memory system that stores stereo audio signals, a removable media, such as a compact disc or a DVD, or a wired and/or wireless receiver that receives the stereo audio signals from another device over a wired and/or wireless interface. These signals can include, for example, Internet streaming, MP3, AAC, WMA, RealAudio and/or other stereo audio signals.

Left and right channel stereo loudspeakers 12L, 12R, respectively, are provided. Crosstalk cancellation circuitry/methods 210, also referred to herein as a crosstalk canceller 210, may be provided that is configured to apply more crosstalk cancellation delay to a difference signal between the left and right stereo audio signals Lin, Rin, than to a sum signal of the left and right channel stereo audio signals. Stated differently, “difference signal delay>sum signal delay”. A stereo amplifier 220 is configured to amplify the left and right stereo audio output signals Lout, Rout, respectively, to which crosstalk cancellation has been applied by the crosstalk cancellation circuits/methods 210, and to provide the signals so amplified to the left and right channel loudspeakers 12L, 12R, respectively. It will be understood that the stereo amplifier 220 may be embodied as an integrated stereo amplifier or as two separate monophonic amplifiers.

As noted above, in FIG. 5, the crosstalk canceller 210 provides a difference signal delay that is greater than a sum signal delay. Greater or smaller delay may be provided by applying longer crosstalk cancellation delay signal time and/or larger crosstalk cancellation delay signal scaling to the difference signal than to the sum signal. The delay may be frequency independent or may vary with frequency. For example, a relatively long delay may be applied to the difference signal and a relatively short, or substantially no, delay may be applied to the sum signal. Alternatively, similar length delays may be applied, but at greatly reduced delay signal scaling for the sum signal. The crosstalk canceller 210 may include a delay element/step that is configured to generate a crosstalk cancellation signal that is greater for the difference signal than for the sum signal. Many specific embodiments will be described in detail below.

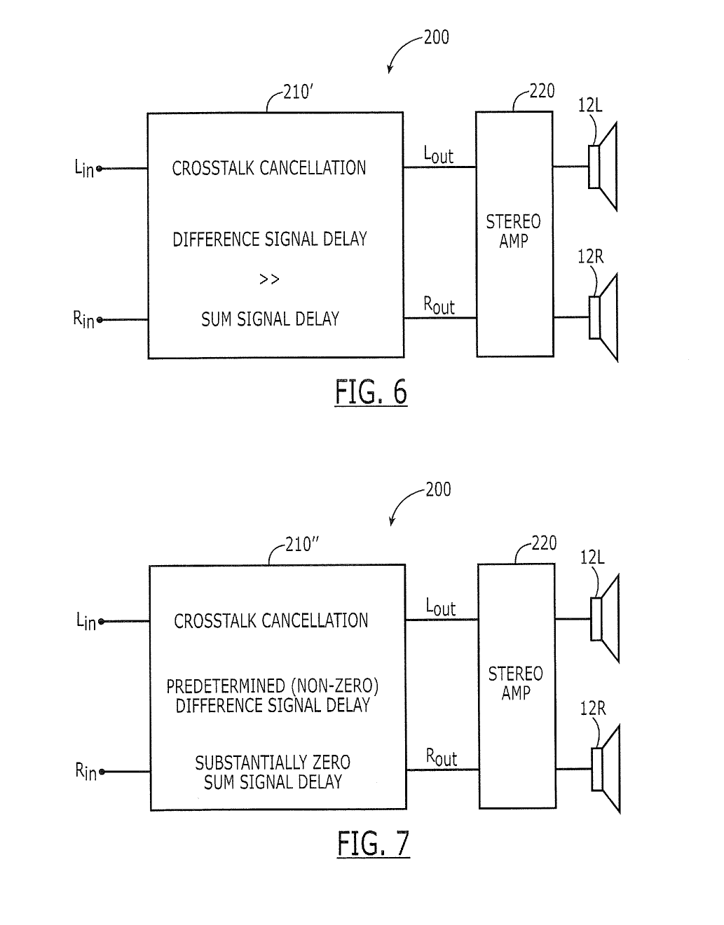

FIG. 6 is a block diagram of systems and methods according to other embodiments of the invention. In these embodiments, the crosstalk canceller 210′ is configured to apply much more (>>) crosstalk cancellation delay to the difference signal than to the sum signal. For example, at least ten times more crosstalk cancellation (delay time and/or signal scaling) may be applied to the difference signal than to the sum signal.

FIG. 7 is a block diagram of crosstalk cancellation systems/methods according to still other embodiments of the present invention. In these embodiments, a predetermined (non-zero) crosstalk cancellation delay is applied to the difference signal, whereas substantially no crosstalk cancellation delay is applied to the sum signal. It will be understood that the term “substantially no” or “substantially zero” crosstalk cancellation delay means that a separate delay element that is embodied in discrete circuitry or in a digital signal processor, is not provided. There may be some inherent delay that is produced due to the spacing between discrete circuit elements and/or the sequential processing of instructions in a digital signal processor, but a separate delay element is not provided.

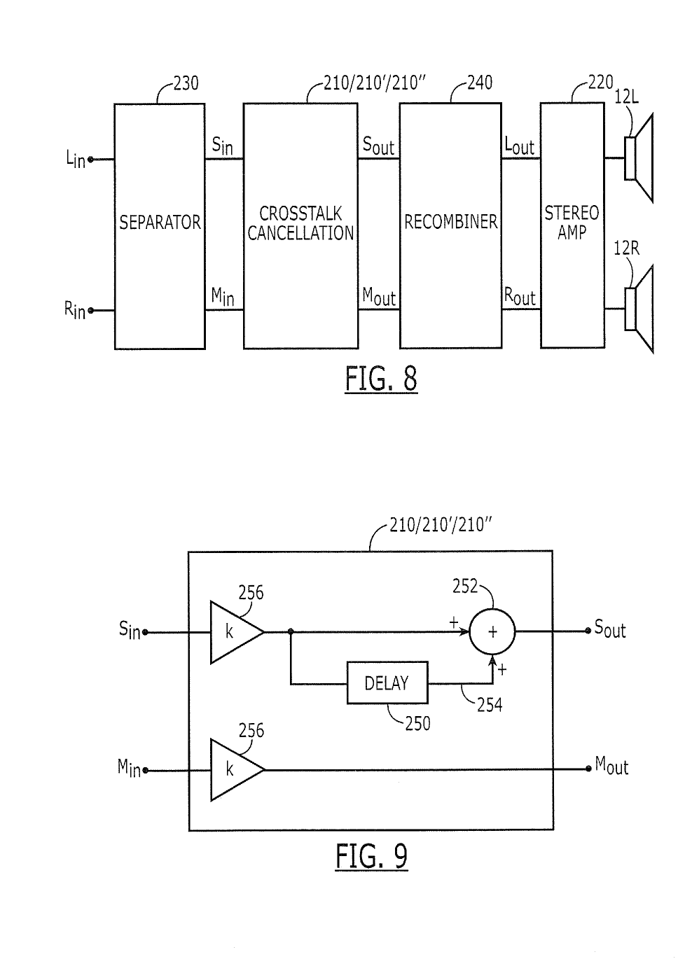

FIG. 8 is a block diagram of audio reproducing systems/methods according to still other embodiments of the present invention. In these systems/methods, a separator 230 is provided that is configured to separate the left and right channel stereo audio signals Lin, Rin into sum and difference signals Min, Sin, respectively. For purposes of notation, the sum, monophonic, center, or middle signal will be referred to herein by “M”, and the difference or side signal will be referred to herein by “S”. A crosstalk canceller 210/210′/210″ according to any of the embodiments described above is configured to apply the more crosstalk cancellation delay to the difference signal than to the sum signal. Finally, a recombiner 240 is configured to recombine the difference signal Sout to which the more crosstalk cancellation delay has been applied, and the sum signal Mout to which less crosstalk cancellation delay has been applied, to obtain the crosstalk canceled left and right channel stereo audio signal Lout, Rout.

FIG. 9 is a block diagram of crosstalk cancellation circuits/methods 210/210′/210″ according to various embodiments of the present invention. As shown in FIG. 9, a delay element 250 is responsive to the difference signal Sin, to generate a delayed replica 254 of the difference signal Sin. The delayed replica may be frequency independent or may have delay and/or amplitude that varies with frequency. A combiner 252 is configured to sum the difference signal Sin and the delayed replica of the difference signal 254. Note the asymmetric nature of the crosstalk canceller of FIG. 9. In particular, the sum signal Min is not delayed, and a delayed replica of the sum signal Min is not combined with the sum signal Min, to produce a crosstalk canceled sum output signal. Thus, there is no delay element that is responsive to the sum signal Min to generate a delayed replica of the sum signal Min, and there is no combiner that is configured to combine the sum signal Min and the delayed replica of the sum signal Min. The crosstalk canceller 210/210′/210″ therefore is not configured to combine the sum signal and a delayed replica thereof. It will be understood that in embodiments of FIG. 9, as well as the other embodiments described herein, various scalings of the various signals may take place as is desirable for implementing embodiments of the invention. For example, scalers 256 may be added as desirable to scale by a factor k, where k can be <1, =1, or >1.

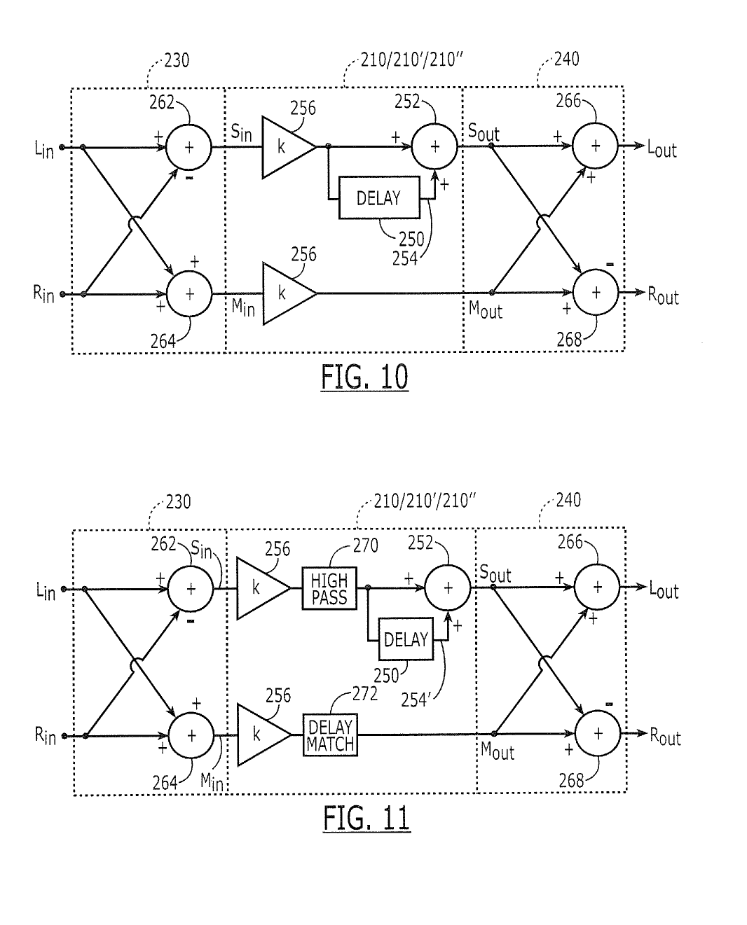

FIG. 10 is a block diagram of devices/circuits/methods according to other embodiments of the present invention. As shown, the separator 230 may be embodied as a first combiner 262 that is responsive to the left and right channel stereo audio signals Lin, Rin, to generate the difference signal Sin, and a third combiner 264 that is responsive to the left and right channel stereo audio signals Lin, Rin to generate to the sum signal Min. The sum signal Mout that appears at the recombiner 240 is free of a crosstalk canceled sum signal. Moreover, the recombiner 240 may be embodied by a fourth combiner 266 that is responsive to the crosstalk canceled difference signal Sout and to the sum signal Mout that is free of a crosstalk canceled sum signal, to generate the left channel stereo signal output signal Lout. The recombiner 240 may also include a fifth combiner 268 that is responsive to the crosstalk canceled difference signal Sout and the sum signal Mout that is free of a crosstalk canceled sum signal, to generate the right channel output signal Rout. The crosstalk cancellation circuitry/method 2101210′/210″ may be embodied by a delay element 250 and a second combiner 254, substantially as was described in connection with FIG. 9. Thus, a crosstalk canceled difference signal 254 is produced by the delay element 250, whereas the sum signal output Mout is a replica of the sum signal input Min, without substantial delay. It will be understood that scalers may be used throughout embodiments of FIG. 10 to provide amplification/attenuation, as desired. For example, scalers 256 may be added as desirable to scale by a factor k, where k can be <1, =1, or >1. It will also be understood that, in some embodiments, the first and fifth combiners 262 and 268 comprise subtractors, whereas the second, third and fourth combiners 252, 266 and 264 comprise summers, as illustrated.

FIG. 11 is a block diagram of circuits/methods according to other embodiments of the present invention. In these circuits/methods, a high pass filter 270 is added between the first combiner 262 and the delay element 250, such that the delay element 250 is responsive to a high pass filtered difference signal to generate a high pass filtered delayed replica 254′ of the difference signal, and the second combiner 252 is responsive to the high pass filtered difference signal and to the high pass filtered delayed replica 254′ of the difference signal, to generate the crosstalk canceled difference signal Sout. A small delay match element 272 may be inserted between the third and fifth combiners 264 and 268, to compensate for the small delay that may be introduced by the high pass filter 270, for example when the high pass filter 270 is embodied in a digital signal processor. As will be described below, the high pass filter 270 can attenuate inaudible side signal frequencies and thereby reduce clipping distortion. Again, scalers can be added throughout to provide amplification/attenuation as desired. For example, scalers 256 may be added as desirable to scale by a factor k, where k can be <1, =1, or >1.

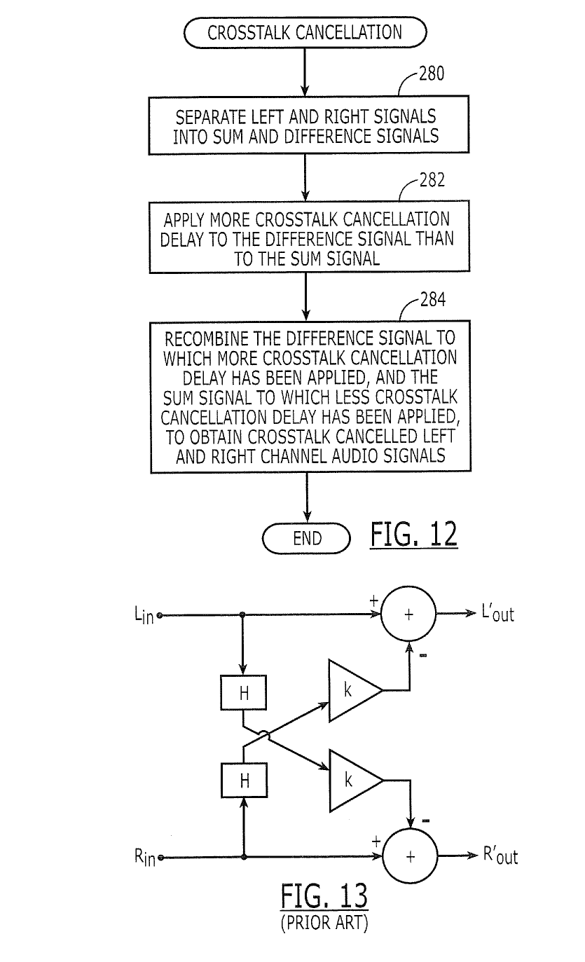

FIG. 12 is a flowchart of operations that maybe performed to provide crosstalk cancellation according to various embodiments of the invention that are illustrated, for example, in FIGS. 8-10. Analogous methods may be provided for any of the block diagrams that are illustrated herein. Referring to FIG. 12, at Block 280, the left and right channel stereo audio signals are separated into sum and difference signals. These operations may be performed, for example, by the separator 230. At Block 282, more crosstalk cancellation delay is applied to the difference signal than to the sum signal. These operations may be performed, for example, by Blocks 210/210′/210″. Finally, at Block 284, the difference signal, to which more crosstalk cancellation delay has been applied, may be combined with the sum signal, to which less crosstalk cancellation delay has been applied, to obtain crosstalk-canceled left and right channel audio signals. Operations of Block 284 may be embodied, for example, by Block 240.

Other embodiments of the present invention will now be described. Moreover, without wishing to be bound by any theory of operation, a rigorous engineering analysis will be presented to compare and contrast various embodiments of the present invention with conventional crosstalk cancellation systems/methods.

In particular, as was described above, operators and end users are interested in cell phones and other electronic devices with stereo loudspeakers for a richer experience of music, video games, ringtones, etc. In one model of a small cell phone, such as the Deena W760i, marketed by Sony Ericsson Mobile Communications, the assignee of the present invention, the stereo loudspeaker ports are separated by about 23 mm. Without crosstalk cancellation (CTC), such closely-spaced loudspeakers are perceived by the user as monophonic source at distances of about 400 mm or more from the ears.

FIG. 13 is a block diagram of a conventional crosstalk cancellation circuit. The H (delay) block matches the difference in the path delay, and optionally in the frequency response, between the two speaker outputs to one ear. The delay H can be independent of frequency or may have delay and/or amplitude that varies with frequency. The parameter k is a tuning parameter between 0 (no CTC) and 1 (complete CTC). L and R represent the left and right signals, respectively. In this conventional circuit, a delayed and out-of-phase version of Lin is added to Rin so that Lin is canceled at the right ear, with a symmetrical action on Rin to the left ear.

For purposes of analysis, consider what happens when Lin and Rin are the same (mono). The inputs to the H blocks can be reversed without any change in the output. The H block can be neglected/bypassed when it has a delay that is less than about 1/10 of a wavelength of the audio signal. In the above-mentioned Deena W760i phone, with a loudspeaker separation of 23 mm, a delay time H=21 μs may be used, and H has negligible effect up to a wavelength of about 210 μs or about 4.8 kHz. Thus, in embodiments of FIG. 13, with mono signals below 4.8 kHz, each channel is effectively scaled by k before subtraction from itself which results in a gain of (1−k). With k=0.7, the gain factor is 0.3 or −10.5 dB.

Continuing with the analysis, the bass and the lead singer in stereo recordings are generally mono (i.e., centered), and most of the music power is in the frequencies below about 4.8 kHz, so almost all the music is attenuated by about 10.5 dB in this cell phone. It also sounds strange that the off-center instruments and singers, which do not receive the attenuation, sound louder than the bass and lead singer. Given the small speakers and amplifiers in a cell phone, this 10.5 dB attenuation also produces a potentially unusable electronic audio reproducing system that may not be able to produce satisfying loudness. This 10.5 dB attenuation may therefore significantly reduce the performance of cell phones with stereo loudspeakers.

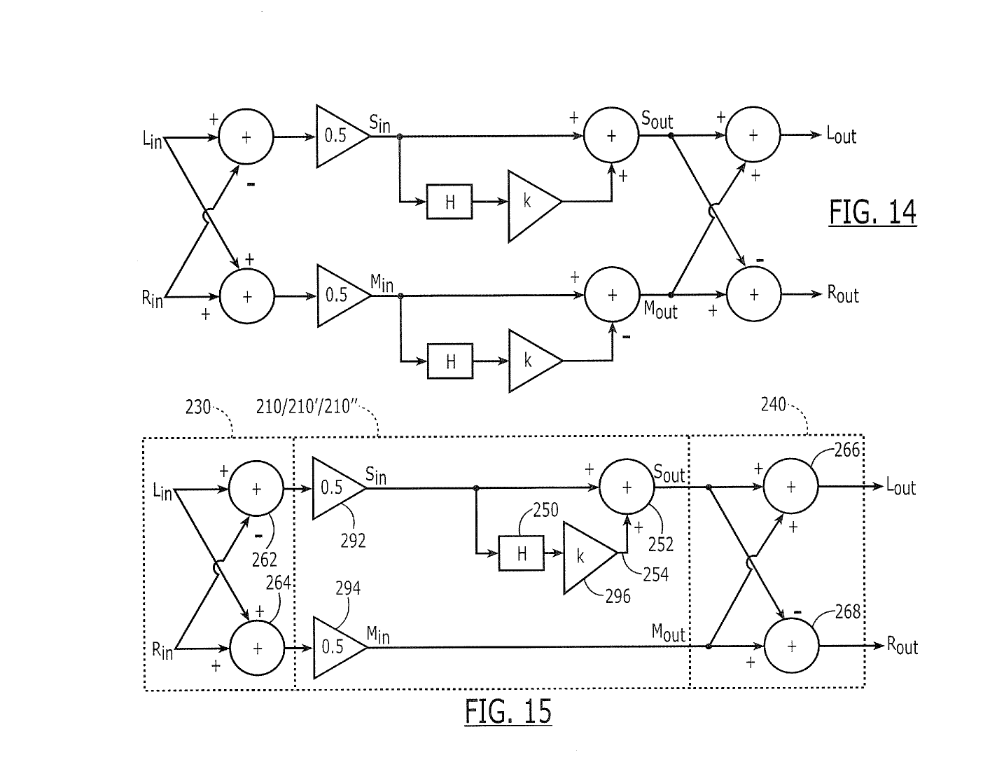

The analysis continues by transforming the topology of FIG. 13 into a middle-side topology, where the middle signal M=L+R (i.e., sum, center or mono) and the side signal S=L−R (i.e., difference). FIG. 14 has the same transfer function as FIG. 13, as will now be shown mathematically:

Referring to FIG. 13:

Lout=Lin−k*H*Rin; and

Rout=Rin−k*H*Lin.

Referring to FIG. 14:

Sin=0.5*(Lin−Rin); and

Min=0.5*(Lin+Rin).

Thus:

Sout=Sin+k*H*Sin=Sin*(1+k*H)=0.5*(Lin−Rin)*(1+k*H)=0.5*Lin*(1+k*H)+0.5*Rin*(−1−k*H), and

Mout=Min−k*H*Min=Min*(1−k*H)=0.5*(Lin+Rin)*(1−k*H)=0.5*Lin*(1−k*H)+0.5*Rin*(1−k*H).

Thus:

Lout=Sout+Mout=0.5*Lin*(1+k*H+1−k*H)+0.5*Rin*(−1−k*H+1−k*H)=0.5*Lin*2+0.5*Rin*(−2*k*H)=Lin−k*H*Rin,

which is the same as FIG. 13.

Moreover,

Rout=Mout−Sout=0.5*Lin*(1−k*H−1−k*H)+0.5*Rin*(1−k*H+1+k*H)=0.5*Lin*(−2*k*H)+0.5*Rin*2=Rin−k*H*Lin,

which is the same as FIG. 13.

Thus, the transfer functions of FIGS. 13 and 14 are the same.

Continuing with the analysis, and recognizing that a mono signal has no side component, FIG. 15 shows how FIG. 14 may be modified to reduce or avoid attenuation on the middle (mono) component. In FIG. 15, like numbers to FIG. 10 have been used.

Referring to FIG. 15, for a mono signal, Lin=Rin, Sin=0 and Sout=0. Also, Lout=Rout=Mout=Min=Lin=Rin, so loudness is preserved (10.5 dB louder than FIG. 13). In particular, note that the outputs Lout/Rout do not contain any contribution from the cancellation signal produced by the delay element H 250.

Now consider the behavior with a signal on one input channel only, for example Rin=0. The result is Sin=Min=Mout=0.5*Lin, Sout=(0.5+0.5*k*H)Lin, Lout=Lin+0.5*k*H*Lin, and Rout=−0.5*k*H*Lin. For frequencies below the point where H is about 1/10 of a wavelength (4.8 kHz for H=21 μs for 23 mm loudspeaker separation), H is effectively bypassed, and Lout and Rout sum acoustically to Lin. For higher frequencies, the crosstalk cancellation provides stereo effects to the two ears. Moreover, since the acoustic sum of Lout and Rout contains Lin unmodified, loudness is preserved.

There are conventional analog stereo enhancement circuits that may have different transfer functions for the middle and side components of the stereo signal. For example, consider the “DIY Passive Crossfeed Filter” for a headphone amplifier on the Meier-Audio website (meier-audio.homepage.t-online.de/) that illustrates a 2 k Ω resistor between the left and right channels. However, these circuits are not crosstalk cancellation circuits, which contain at least one delay element to provide crosstalk cancellation delay to compensate for the path difference between the ears. Moreover, there is no need to modify a DIY Passive Crossfeed Filter for a headphone amplifier because path length differences between loudspeakers and the ears do not appear to be a consideration for headphones.

There are also conventional processors that use head-related transfer function (HRTF) filters to change the apparent direction of sounds, but these generally are designed to process each input signal independently. They do not appear to provide different transfer functions for middle (sum) and side (difference) components, as is provided by various embodiments of the invention to allow satisfying loudness from small, closely-spaced speakers.

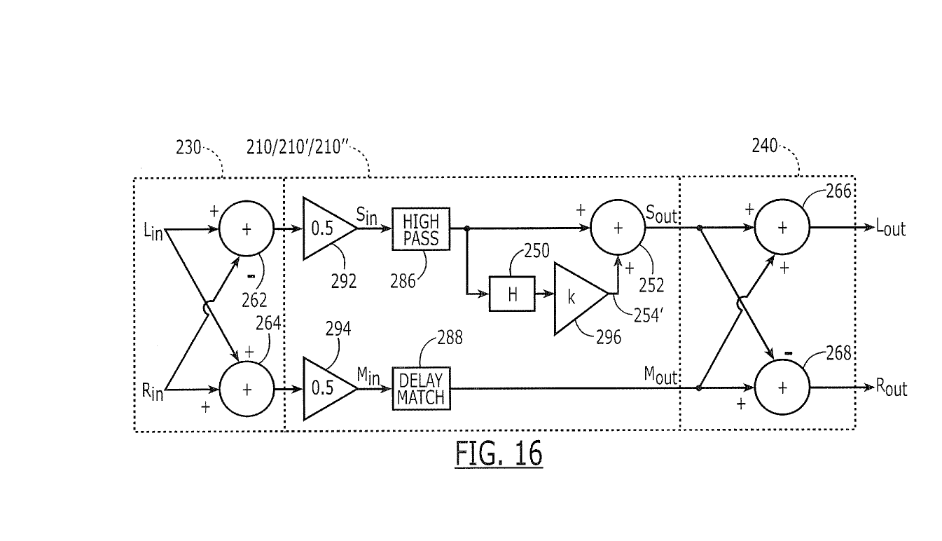

FIG. 16 illustrates other embodiments of the invention. Like numbers to FIG. 11 are used. In FIG. 16, a high pass filter 286 is added to the side signal Sin so that low frequencies are removed that otherwise would cancel acoustically. In the Deena W760i phone, for example, frequencies below about 4.8 kHz would be attenuated. By attenuating inaudible side-signal frequencies, clipping distortion may be reduced at Sout, Lout and/or Rout, power amplifier power may be reduced and/or speaker distortion may be reduced. To keep the Sout and Mout signals time aligned, a delay-match block 288 may be added to the middle signal Min to match the delay of the high pass filter 286 in the side signal Sin.

Note that the 0.5-value scalers 292, 294 at the front end could be replaced by the general scaler g, which can be a different value to change or optimize the loudness versus clipping distortion at Sout, Lout and/or Rout. Note also that additional scalers (not shown) could be added after the high pass filter 286 or at Sout to boost the stereo widening effect. Finally, in some embodiments of FIGS. 15 and 16, the delay H=21 μs and the scaling k=0.7.

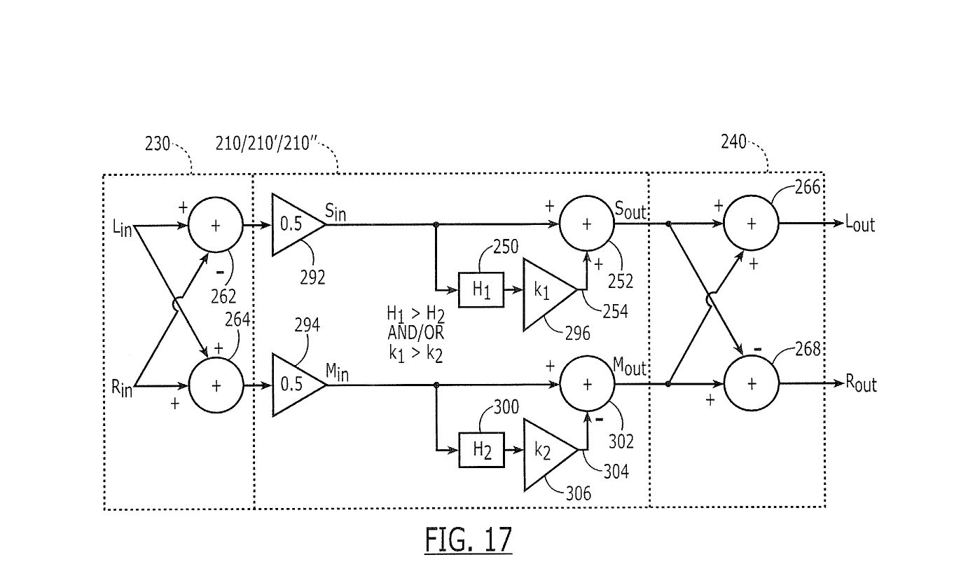

FIG. 17 illustrates other embodiments of the invention, and may be regarded as a generalization of FIG. 15. In particular, in FIG. 17, a second delay element 300, a second amplifier 306, and a sixth combiner 302 have been added for the middle signal Min in the echo canceller 210/210′/210″ to generate a sum crosstalk cancellation delay signal 304. In these embodiments, more crosstalk cancellation delay is applied to the difference signal Sin than to the sum signal Min, by applying a longer crosstalk cancellation signal delay H1 to the difference signal Sin and a shorter crosstalk cancellation delay H2 to the sum signal Min, or by applying larger crosstalk cancellation delay scaling k1 to the difference signal Sin than the crosstalk cancellation delay signal scaling k2 that is applied to the sum signal Min, or both. In other words, as illustrated in FIG. 17, H1>H2 and/or k1>k2. When H2 or K2 is 0, embodiments of FIG. 17 reduce to embodiments of FIG. 15.

Accordingly, stereo loudspeaker crosstalk cancellation systems, methods and devices according to various embodiments of the invention can include at least one delay element for cancellation signal generation, where the cancellation signal is asymmetric as between sum and difference signals in the left and right channel stereo audio signals. In some embodiments, the cancellation signal is substantially zero for a mono signal. Various embodiments of the invention can provide satisfying loudness and a rich stereo sound experience from a small device. Moreover, for DSP embodiments, an increase in cost may not be needed.

Many different embodiments have been disclosed herein, in connection with the above description and the drawings. It will be understood that it would be unduly repetitious and obfuscating to literally describe and illustrate every combination and subcombination of these embodiments. Accordingly, the present specification, including the drawings, shall be construed to constitute a complete written description of all combinations and subcombinations of the embodiments described herein, and of the manner and process of making and using them, and shall support claims to any such combination or subcombination.

In the drawings and specification, there have been disclosed embodiments of the invention and, although specific terms are employed, they are used in a generic and descriptive sense only and not for purposes of limitation, the scope of the invention being set forth in the following claims.

What is claimed is:

1. A crosstalk cancellation system for left and right channel stereo audio signals, the crosstalk cancellation system comprising:
circuitry that is configured to apply more crosstalk cancellation delay to a difference signal between the left and right stereo audio signals, than to a sum signal of the left and right channel stereo audio signals.

2. A crosstalk cancellation system according to claim 1 wherein the circuitry is configured to apply a predetermined crosstalk cancellation delay to the difference signal, and substantially no crosstalk cancellation delay to the sum signal.

3. A crosstalk cancellation system according to claim 1 wherein the circuitry is configured to apply at least ten times more crosstalk cancellation delay to the difference signal than to the sum signal.

4. A crosstalk cancellation system according to claim 1 wherein the circuitry comprises:
a separator that is configured to separate the left and right channel stereo audio signals into the sum and difference signals;
a crosstalk canceller that is configured to apply the more crosstalk cancellation delay to the difference signal than to the sum signal; and
a recombiner that is configured to recombine the difference signal to which the more crosstalk cancellation delay has been applied, and the sum signal to which less crosstalk cancellation delay has been applied, to obtain crosstalk-canceled left and right channel stereo audio signals.

5. A crosstalk cancellation system according to claim 1 wherein the circuitry comprises:
a delay element that is responsive to the difference signal to generate a delayed replica of the difference signal; and
a combiner that is configured to sum the difference signal and the delayed replica of the difference signal;
wherein the crosstalk cancellation system is not configured to combine the sum signal and a delayed replica thereof.

6. A crosstalk cancellation system according to claim 4 wherein the crosstalk canceller comprises:
a delay element that is responsive to the difference signal to generate a delayed replica of the difference signal; and
a combiner that is configured to sum the difference signal and the delayed replica of the difference signal;
wherein the crosstalk cancellation system is not configured to combine the sum signal and a delayed replica thereof; and
wherein the recombiner is responsive to the combiner and to the sum signal.

7. A crosstalk cancellation system according to claim 1 wherein the circuitry is configured to apply more crosstalk cancellation delay by applying longer crosstalk cancellation delay signal time and/or larger crosstalk cancellation delay signal scaling to the difference signal, than to the sum signal.

8. A crosstalk cancellation system according to claim 1 wherein the circuitry comprises:
a first combiner that is responsive to the left and right channel stereo audio signals to generate the difference signal;
a delay element that is responsive to the difference signal to generate a delayed replica of the difference signal;
a second combiner that is responsive to the difference signal and to the delayed replica of the difference signal to generate a crosstalk canceled difference signal;
a third combiner that is responsive to the left and right channel stereo audio signals to generate the sum signal that is free of a crosstalk canceled sum signal;
a fourth combiner that is responsive to the crosstalk canceled difference signal and to the sum signal that is free of a crosstalk canceled sum signal to generate a left channel output signal; and
a fifth combiner that is responsive to the crosstalk canceled difference signal and to the sum signal that is free of a crosstalk canceled sum signal to generate a right channel output signal.

9. A crosstalk cancellation system according to claim 8 further comprising:
a high pass filter between the first combiner and the delay element such that the delay element is responsive to a high pass filtered difference signal to generate a high pass filtered delayed replica of the difference signal, and the second combiner is responsive to the high pass filtered difference signal and to the high pass filtered delayed replica of the difference signal to generate the crosstalk canceled difference signal.

10. A crosstalk cancellation system according to claim 8 wherein the first and fifth combiners comprise subtractors and wherein the second, third and fourth combiners comprise summers.

11. A crosstalk cancellation system according to claim 1 wherein the circuitry comprises a delay element that is configured to generate a crosstalk cancellation signal that is greater in time and/or amplitude for the difference signal than for the sum signal.

12. A crosstalk cancellation system according to claim 1 wherein the circuitry comprises a delay element that is configured to generate a delay that is frequency independent or that varies with frequency in delay and/or amplitude.

13. An electronic audio reproducing system comprising:
a source of left and right channel stereo audio signals;
left and right channel stereo loudspeakers;
a crosstalk cancellation circuit that is configured to apply more crosstalk cancellation delay to a difference signal between the left and right stereo audio signals, than to a sum signal of the left and right channel stereo audio signals; and
a stereo amplifier that is configured to amplify the left and right stereo audio signals to which crosstalk cancellation has been applied by the crosstalk cancellation circuit and to provide the signals so amplified to the left and right channel stereo loudspeakers.

14. An electronic audio reproducing system according to claim 13 wherein the crosstalk cancellation circuit is configured to apply a predetermined crosstalk cancellation delay to the difference signal, and substantially no crosstalk cancellation delay to the sum signal.

15. An electronic audio reproducing system according to claim 13 wherein the crosstalk cancellation circuit is configured to apply at least ten times more crosstalk cancellation delay to the difference signal than to the sum signal.

16. An electronic audio reproducing system according to claim 13 wherein the crosstalk cancellation circuit comprises:
a separator that is configured to separate the left and right channel stereo audio signals into the sum and difference signals;
a crosstalk canceller that is configured to apply the more crosstalk cancellation delay to the difference signal than to the sum signal; and
a recombiner that is configured to recombine the difference signal to which the more crosstalk cancellation delay has been applied, and the sum signal to which less crosstalk cancellation delay has been applied, to obtain crosstalk-canceled left and right channel stereo audio signals.

17. An electronic audio reproducing system according to claim 13 wherein the crosstalk cancellation circuit comprises:
a delay element that is responsive to the difference signal to generate a delayed replica of the difference signal; and
a combiner that is configured to sum the difference signal and the delayed replica of the difference signal;
wherein the crosstalk cancellation circuit is not configured to combine the sum signal and a delayed replica thereof.

18. An electronic audio reproducing system according to claim 16 wherein the crosstalk canceller comprises:
a delay element that is responsive to the difference signal to generate a delayed replica of the difference signal; and
a combiner that is configured to sum the difference signal and the delayed replica of the difference signal;
wherein the crosstalk cancellation circuit is not configured to combine the sum signal and a delayed replica thereof; and
wherein the recombiner is responsive to the combiner and to the sum signal.

19. An electronic audio reproducing system according to claim 13 wherein the crosstalk cancellation circuit is configured to apply more crosstalk cancellation delay by applying longer crosstalk cancellation delay signal time and/or larger crosstalk cancellation delay signal scaling to the difference signal, than to the sum signal.

20. An electronic audio reproducing system according to claim 13 wherein the crosstalk cancellation circuit comprises:
a first combiner that is responsive to the left and right channel stereo audio signals to generate the difference signal;
a delay element that is responsive to the difference signal to generate a delayed replica of the difference signal;
a second combiner that is responsive to the difference signal and to the delayed replica of the difference signal to generate a crosstalk canceled difference signal;
a third combiner that is responsive to the left and right channel stereo audio signals to generate the sum signal that is free of a crosstalk canceled sum signal;
a fourth combiner that is responsive to the crosstalk canceled difference signal and to the sum signal that is free of a crosstalk canceled sum signal to generate a left channel output signal; and
a fifth combiner that is responsive to the crosstalk canceled difference signal and to the sum signal that is free of a crosstalk canceled sum signal to generate a right channel output signal.

21. An electronic audio reproducing system according to claim 20 further comprising:
a high pass filter between the first combiner and the delay element such that the delay element is responsive to a high pass filtered difference signal to generate a high pass filtered delayed replica of the difference signal, and the second combiner is responsive to the high pass filtered difference signal and to the high pass filtered delayed replica of the difference signal to generate the crosstalk canceled difference signal.

22. An electronic audio reproducing system according to claim 21 wherein the first and fifth combiners comprise subtractors and wherein the second, third and fourth combiners comprise summers.

23. An electronic audio reproducing system according to claim 13 wherein the circuitry comprises a delay element that is configured to generate a crosstalk cancellation signal that is greater in time and/or amplitude for the difference signal than for the sum signal.

24. An electronic audio reproducing system according to claim 13 wherein the circuitry comprises a delay element that is configured to generate a delay that is frequency independent or that varies with frequency in delay and/or amplitude.

25. A crosstalk cancellation method for left and right channel stereo audio signals, the crosstalk cancellation method comprising:
processing the left and right channel stereo audio signals so as to apply more crosstalk cancellation delay to a difference signal between the left and right stereo audio signals, than to a sum signal of the left and right channel stereo audio signals.

26. A crosstalk cancellation method according to claim 25 wherein the left and right channel stereo audio signals are processed so as to apply a predetermined crosstalk cancellation delay to the difference signal, and substantially no crosstalk cancellation delay to the sum signal.

27. A crosstalk cancellation method according to claim 25 wherein the left and right channel stereo audio signals are processed so as to apply at least ten times more crosstalk cancellation delay to the difference signal than to the sum signal.

28. A crosstalk cancellation method according to claim 25 wherein the processing comprises:
separating the left and right channel stereo audio signals into the sum and difference signals;
applying the more crosstalk cancellation delay to the difference signal than to the sum signal; and
recombining the difference signal to which the more crosstalk cancellation delay has been applied, and the sum signal to which less crosstalk cancellation delay has been applied, to obtain crosstalk-canceled left and right channel stereo audio signals.

29. A crosstalk cancellation method according to claim 25 wherein the processing comprises:
generating a delayed replica of the difference signal; and
summing the difference signal and the delayed replica of the difference signal without combining the sum signal and a delayed replica thereof.

30. A crosstalk cancellation method according to claim 25 wherein the processing comprises applying longer crosstalk cancellation delay signal time and/or larger crosstalk cancellation delay signal scaling to the difference signal, than to the sum signal.

31. A crosstalk cancellation method according to claim 25 wherein the processing comprises:
subtracting the left and right channel stereo audio signals from one another to generate the difference signal;
generating a delayed replica of the difference signal;
adding the difference signal and the delayed replica of the difference signal to generate a crosstalk canceled difference signal;
adding the left and right channel stereo audio signals to generate the sum signal that is free of a crosstalk canceled sum signal;
adding the crosstalk canceled difference signal and the sum signal that is free of a crosstalk canceled sum signal to generate a left channel output signal; and
subtracting the crosstalk canceled difference signal and the sum signal that is free of a crosstalk canceled sum signal from one another to generate a right channel output signal.

32. A crosstalk cancellation method according to claim 31 further comprising:
generating a high pass filtered delayed replica of the difference signal, and wherein the adding the difference signal and the delayed replica comprises adding the high pass filtered difference signal and the high pass filtered delayed replica of the difference signal to generate the crosstalk canceled difference signal.
